(19) United States
(12) Patent Application Publication
(10) Pub. No.: US 2016/0359864 A1
(43) Pub. Date: Dec. 8, 2016

(54) SYSTEM AND METHOD FOR CONTROLLING RESOURCES IN AN INTERNET OF THINGS NETWORK

(71) Applicant: HCL Technologies Limited, Noida (IN)

(72) Inventors: Jasbir Singh Dhaliwal, Noida (IN); Sankar Uma Tammana, Noida (IN); Sanjeev Kumar Sharma, Noida (IN)

(21) Appl. No.: 15/130,756

(22) Filed: Apr. 15, 2016

(30) Foreign Application Priority Data
Jun. 4, 2015 (IN) 1659/DEL/2015

(51) Int. Cl. H04L 29/06; H04W 12/08

(52) U.S. Cl. CPC H04L 63/102; H04L 63/0861; H04L 63/0853; H04W 12/08

(57) ABSTRACT

The present disclosure relates to system(s) and method(s) for systems and methods for controlling resources in an Internet of Things (IoT) network. The system comprises a processor and a memory coupled to the processor, wherein the processor is configured for detecting presence of a user in a vicinity of an Internet of Things (IoT) network. Further, the processor is configured for receiving the biometric authentication information and the profile identifier from the wearable device. The biometric authentication information is generated by the wearable device based on comparison of a biometric sample captured from the user with a golden copy of the biometric sample. Furthermore, the processor is configured for identifying a user profile associated with the user based on the biometric authentication information and the profile identifier. Once the user profile is identified, in the next step, the processor is configured for calibrating the one or more resources in the IoT network based on the user profile.

### CROSS-REFERENCE TO RELATED APPLICATIONS AND PRIORITY

The present application claims benefit from Indian Complete Patent Application No. 1659/DEL/2015, filed on Jun. 4, 2015, the entirety of which is hereby incorporated by reference.

### TECHNICAL FIELD

The present disclosure in general relates to the field of Internet of Things. More particularly, the present invention relates to a system and method for controlling resources in an Internet of Things network.

### BACKGROUND

The development in the field machine to machine communication and Internet of Things (IoT) has marginally increased with the development in communication protocols. Communication protocol such as ZigBee is widely used in IoT networks such as smart homes, smart cars and the like. In a smart home environment, all the resources communicate with a central gateway, wherein the central gateway may be controlled by an authorized user. The resources in the smart home may include electronic devices such as a fan, an Air conditioner, a washing machine, a refrigerator, tube lights, light bulbs, and the like.

Some of these resources may affect more than one authorized users in the smart home. While authorized users share the common resource, each user has his/her own preferences related to configuration of resources. Each authorized user may want to set his ambience/setting of the resources in the IoT network based on his individual interests. In the smart homes environment, there are different approaches adopted for personalizing ambience. However, these approaches do not verify a user identity by way of secure authentication. Furthermore, if more than one user is present in the IoT network, then the users may have multiple preferences, which may change over time.

Based on the above, there is a need for a system and method which can resolve conflicts between multiple users competing to access multiple resources in an IoT network.

### SUMMARY

This summary is provided to introduce aspects related to systems and methods for controlling resources in an internet of things network and the aspects are further described below in the detailed description. This summary is not intended to identify essential features of the claimed subject matter nor is it intended for use in determining or limiting the scope of the claimed subject matter.

In one embodiment, a method for controlling resources in an Internet of Things (IoT) network is disclosed. Initially a processor is configured for detecting presence of a user in a vicinity of an Internet of Things (IoT) network. The presence of the user is detected based on an access control signal received from a wearable device of the user, wherein the access control signal indicates a request for controlling one or more resources in the IoT network. Further, the processor is configured for prompting the wearable device to continuously transmit biometric authentication information and a profile identifier associated with the user at successive time intervals. Further, the processor is configured for receiving the biometric authentication information and the profile identifier from the wearable device. The biometric authentication information is generated by the wearable device based on comparison of a biometric sample captured from the user with a golden copy of the biometric sample. Furthermore, the processor is configured for identifying a user profile associated with the user based on the biometric authentication information and the profile identifier. Further, the processor is configured for calibrating the one or more resources in the IoT network based on the user profile.

In one embodiment, a system for controlling resources in an Internet of Things (IoT) network is disclosed. The system comprises a memory, a processor coupled to the memory, wherein the processor is configured to execute a plurality of instructions stored in the memory for detecting presence of a user in a vicinity of an Internet of Things (IoT) network The presence of the user is detected based on an access control signal received from a wearable device of the user, wherein the access control signal indicates a request for controlling one or more resources in the IoT network. Further, the processor executes a plurality of instructions stored in the memory for prompting the wearable device to continuously transmit biometric authentication information and a profile identifier associated with the user at successive time intervals. Further, the processor executes a plurality of instructions stored in the memory for receiving the biometric authentication information and the profile identifier from the wearable device, wherein the biometric authentication information is generated by the wearable device based on comparison of a biometric sample captured from the user with a golden copy of the biometric sample. Further, the processor executes a plurality of instructions stored in the memory for identifying a user profile associated with the user based on the biometric authentication information and the profile identifier, wherein the user profile is identified from a profile database. Further, the processor executes a plurality of instructions stored in the memory for calibrating the one or more resources in the IoT network based on the user profile.

In one embodiment, a computer program product having embodied computer program for controlling resources in an Internet of Things (IoT) network is disclosed. The computer program product comprises a program code for detecting presence of a user in a vicinity of an Internet of Things (IoT) network, wherein the presence of the user is detected based on an access control signal received from a wearable device of the user, wherein the access control signal indicates a request for controlling one or more resources in the IoT network. The computer program further comprises a program code for prompting the wearable device to continuously transmit biometric authentication information and a profile identifier associated with the user at successive time intervals. The computer program further comprises a program code for receiving the biometric authentication information and the profile identifier from the wearable device, wherein the biometric authentication information is generated by the wearable device based on comparison of a biometric sample captured from the user with a golden copy of the biometric sample. The computer program further comprises a program code for identifying a user profile associated with the user based on the biometric authentication information and the profile identifier, wherein the user profile is identified from a profile database. The computer program further comprises a program code for calibrating the one or more resources in the IoT network based on the user profile.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for controlling resources in an Internet of Things (IoT) network, in accordance with an embodiment of the present subject matter.

FIG. 2 illustrates the system for controlling resources in the Internet of Things (IoT) network, in accordance with an embodiment of the present subject matter.

FIG. 3 illustrates a block diagram for controlling resources in the Internet of Things (IoT) network, in accordance with an embodiment of the present subject matter.

### DETAILED DESCRIPTION

The present disclosure relates to systems and methods for controlling resources in an Internet of Things (IoT) network. The system comprises a processor and a memory coupled to the processor, wherein the processor is configured for detecting presence of a user in a vicinity of an Internet of Things (IoT) network. The presence of the user is detected based on an access control signal received from a wearable device of the user. The access control signal indicates a request by the user of the wearable device for controlling one or more resources in the IoT network. Further, the processor is configured for prompting the wearable device to continuously transmit biometric authentication information and a profile identifier associated with the user at successive time intervals. Further, the processor is configured for receiving the biometric authentication information and the profile identifier from the wearable device. The biometric authentication information is generated by the wearable device based on comparison of a biometric sample captured from the user with a golden copy of the biometric sample. Furthermore, the processor is configured for identifying a user profile associated with the user based on the biometric authentication information and the profile identifier. Further, the processor is configured for calibrating the one or more resources in the IoT network based on the user profile.

While aspects of described system and method for controlling resources in the Internet of Things (IoT) network may be implemented in any number of different computing systems, environments, and/or configurations, the embodiments are described in the context of the following exemplary system.

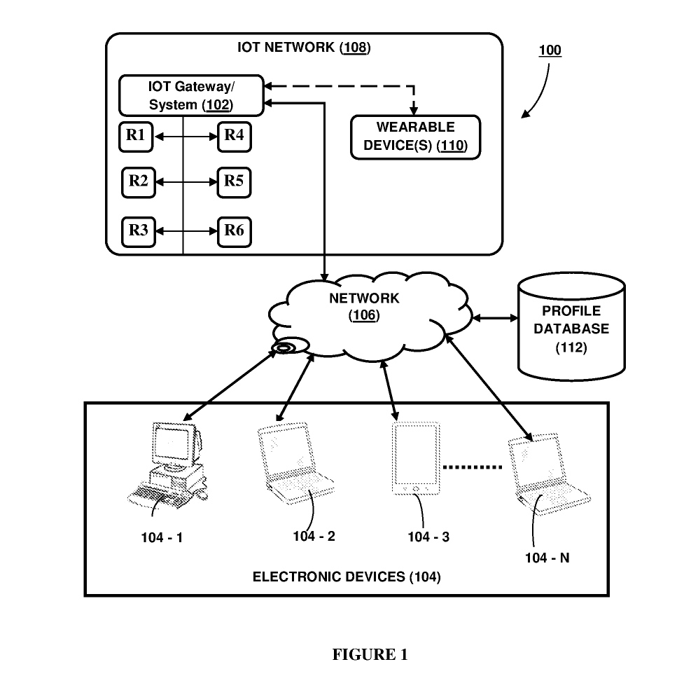

Referring now to FIG. 1, a network implementation 100 of an IoT Gateway 102 hereafter referred to as a system 102 for controlling resources in an Internet of Things (IoT) network. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one embodiment, a user may use the user device 104 to communicate with the system 102 and generate his user profile. The user profile may store different setting for controlling each of the set of resources. Further, the user profile may also record multiple sub-profiles, wherein each sub-profile is distinguished based on the time of the day. Once the user profile is generated, the system 102 stores the user profile in a profile database 112 for future reference.

In one embodiment, a wearable device 110 may communicate with the system 102 over local wireless network selected from ZigBee, Bluetooth, Z-wave, Wi-Fi and the like. Initially each wearable device 110 is register with system 102 for the purpose of pairing with the system 102. After successful registration the system 102 shares the security keys for later communications between the wearable device 110 and the system 102. The system 102 may also store a golden copy of the biometric sample and a profile identifier on the wearable device 110 after successful registration. This information on the wearable device 110 is used for periodic authentication. The periodicity of this biometric authentication may be user configurable. In case the user does not authenticate before expiry of this period, the next applicable profile is activated based on the priority level of each authorized user present in the vicinity of the IoT network 108. The Wearable Device 110 is configured to store authentication information as represented in table 1.

TABLE 1
information stored on wearable device

| Device ID | Device name | authentication information |
|---|---|---|
| Xx:xx:xx:xx:xx:xx:12:34 | Smart watch-1 | 00 00 01 00 |
| Xx:xx:xx:xx:xx:xx:12:35 | Smart band-1 | 00 00 00 01 |
| Xx:xx:xx:xx:xx:xx:12:36 | Smart watch-2 | 00 00 01 00 |

In one embodiment, there may be more than one user in the vicinity of the IoT network 108, wanting to control the resources in the IoT network 108. Each user in the vicinity of the IoT network 108 wears a wearable device 110 having unique profile identifier (e.g. MAC/EUI64/SRNO/Profile-Identifier) to distinguish the user from other users. The user profile associated with each of the users is stored in the profile database 112. Further, the user profile may contain information like user credentials, list of personalized settings for each resource and priority of the user. In one example, the user profiles stored in the profile database 112 are described in table 2.

TABLE 2
User profiles stored in the profile database 112

| | | | Personalized | Biometric | |
|---|---|---|---|---|---|
| Profile | User | | Ambience | imprint/ | |
| Identifier | Name | Wearable Device ID | settings | sample | Priority |
| USER1 | Kid1 | Xx:xx:xx:xx:xx:xx:12:34 | PA1(Default), | Blob1 | P1 |
| | | | PA2 | | |
| USER2 | Kid2 | Xx:xx:xx:xx:xx:xx:12:35 | PA2(Default), | Blob2 | P2 |
| | | | PA3 | | |
| USER3 | Parent1 | Xx:xx:xx:xx:xx:xx:12:36 | PA3(Default), | Blob3 | P0 |
| | | | PA1, PA2 | | |

In one embodiment, whenever a user enters into the vicinity of the IoT network 108, the settings specified in the user profile of the user are activated only after successful biometric authentication at the wearable device 110. The biometric authentication is achieved by any of the biometric identification methods selected from finger printing sensor, face recognition and the like. For the purpose of biometric authentication, the wearable device 110 is configured to capture real-time biometric sample from the user and compare it with the golden copy of the biometric sample stored in the wearable device 110. After periodic timer interval the biometric authentication process is repeated and each of the wearable devices 110 within the vicinity of the IoT network 108 is prompted by the system 102 to provide biometric authentication information and profile identifier. In case if the periodic authentication process fails or a time out occurs, the resource settings specified by a user profile associated with other authenticated user having highest priority is activated.

In one embodiment, the system 102 may enable flexibility to switch from default user profile settings and change the settings based on gestures made by the user. For the purpose of gesture recognition, the wearable device 110 may be equipped with sensors like accelerometer, Gyroscope and the like.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Constrained Application Protocol (CoAP), Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

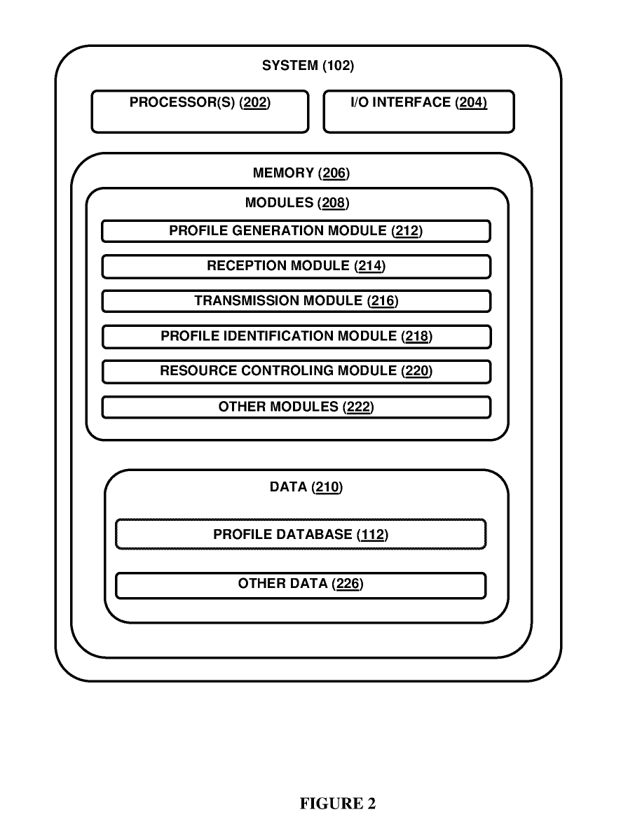

In one embodiment, the IoT network 108 may comprise of a set of resources (R1 to R6). The set of resources may be communicate with the system 102 through wireless communication protocols such as ZigBee, Wi-Fi, Bluetooth, and the like. The system 102 may also communicate with a wearable device 110 of the user using at least one wireless communication protocol when the wearable device 110 is within the vicinity of the IoT network 108. The vicinity of the IoT network 108 is determined based on the range of the wireless communication used in the IoT network 108. Once the wearable device 110 is within the range of the wireless communication enabled by the IoT network 108, the system 102 determines the presence of a user in the vicinity of the IoT network based on an access control signal received from a wearable device 110 of the user. The access control signal indicates a request for controlling one or more resources (R1 to R6) in the IoT network 108. The process of controlling resources in an Internet of Things (IoT) network 108 using continuous biometric authentication is further explained with respect to the FIG. 2.

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a profile generation module 212, a reception module 214, a transmission module 216, a profile identification module 218, resource controlling module 220, and other modules 222. The other modules 222 may include programs or coded instructions that supplement applications and functions of the system 102.

The data 210, amongst other things, serves as a repository for storing data processed, received, and generated by one or more of the modules 208. The data 210 may also include the profile database 112 and other data 226. The profile database 112 is configured to store user profile of at least one authorized user of the IoT network 108. The user profile is generated by capturing preferences, of the authorized user, for each resource in the IoT network 108.

In one embodiment, for capturing the user profile, initially the profile generation module 212 enables the user to provide his preferred settings for each resource in the IoT network 108. The preference of the user may change/vary with time of the day. In order to capture these variations in the preferences, the profile generation module 212 may enable generation of multiple sub-profiles for capturing time based profiles associated with the user in a single user profile. Once the user profile is generated, the system 102 records the user profile in a profile database 112 for future reference.

In the next step, the reception module 214 is configured to detect presence of a user in a vicinity of an Internet of Things (IoT) network. The presence of the user is detected based on an access control signal received from a wearable device 110 of the user. The access control signal indicates a request for controlling one or more resources in the IoT network 108. Further, the transmission module 216 prompts the wearable device 110 to continuously transmit biometric authentication information and a profile identifier associated with the user at successive time intervals. The biometric authentication information is generated by the wearable device based on matching of a biometric sample captured from the user with a golden copy of the biometric sample stored at the wearable device 110. Further, each of the wearable devices 110 is enabled to store profile identifier which is unique for the wearable device 110 and the user of the wearable device 110. In the next step, the biometric authentication information and the profile identifier is received by the reception module 214 from the wearable device 110.

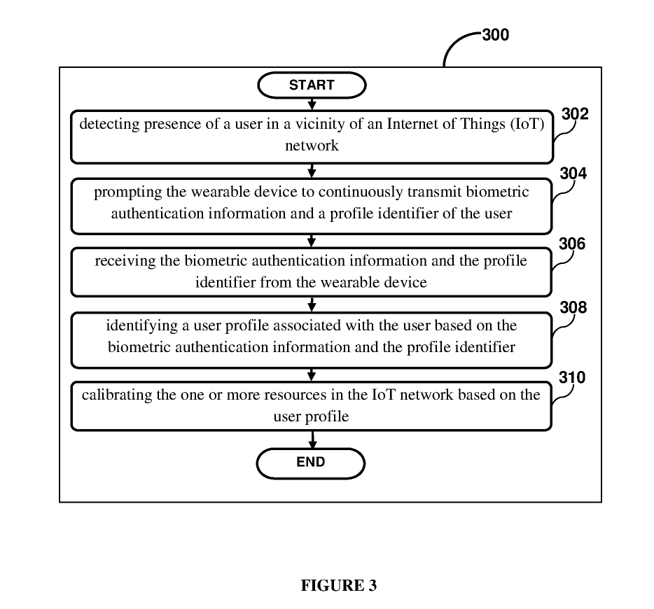

In the next step, the profile identification module 218 is configured to identify a user profile associated with the user, from the profile database 112, based on the biometric authentication information and the profile identifier. Once the user profile is identified, in the next step, the resource controlling module 220 is configured to calibrate one or more resources in the IoT network 108 based on time of the day and different setting specified in the user profile of the user. The process of controlling resources in the IoT network 108 is further explained with respect to the flowchart of FIG. 3.

FIG. 3 represent a block diagram for controlling resources in the IoT network 108. Once the user profile is generated and stored in the profile database 112, at block 302, the reception module 214 is configured to detect presence of the user in the vicinity of an Internet of Things (IoT) network 108. The presence of the user is detected based on an access control signal received from a wearable device 110 of the user. The access control signal indicates a request for controlling one or more resources in the IoT network 108.

At block 304, the transmission module 216 prompts the wearable device 110 to continuously transmit biometric authentication information and the profile identifier associated with the user at successive time intervals. The biometric authentication information is generated by the wearable device 110 based on comparison of a biometric sample captured from the user with a golden copy of the biometric sample stored at the wearable device 110. The biometric sample may be selected from a fingerprint, a pulse rate, a face image, eye retina image and compared with the corresponding golden copy of the biometric sample stored at the wearable device 110. Further, the wearable device 110 is enabled to store profile identifier which is unique for the wearable device and the user of the wearable device 110.

At block 306, the biometric authentication information and the profile identifier is received by the reception module 214 from the wearable device 110.

At block 308, the profile identification module 218 is configured to identify a user profile associated with the user, from the profile database 112, based on the biometric authentication information and the profile identifier. The user profile may store the profile identifier, a wearable device identifier, personalized configuration settings for each resource from the one or more resources and a privilege level of the user. The privilege level of the user is used for resolving conflicts between the user and other users trying to access the one or more resources in the IoT network 108.

At block 310, once the user profile is identified, in the next step, the resource controlling module 220 is configured to calibrate one or more resources in the IoT network 108 based on time of the day and different resource configuration settings specified in the user profile.

In one example, multiple users may try to access one or more resources in the IoT network 108. Each user may have a user profile with multiple time based sub-profiles. The user profile associated with each user is stored in the profile database 112. If more than one users enter in the vicinity of the IoT network 108, the system 102 authenticates each of the users based on biometric authenticating information received from their corresponding wearable devices 110, wherein the biometric authenticating information is generated by the wearable devices 110 using at least one of biometric authentication techniques selected from face-recognition, finger scan, heartbeat, or eye retina scanning. For the purpose of biometric authentication, the wearable device 110 may compare a golden copy of the biometric sample with a biometric sample captured from the users in real-time. Further, after successfully authenticating the users, the system 102 may configure the resources in the IoT network 108 based on the profile of the user with highest priority. The priority of each user may be prerecorded in their corresponding user profiles and is dynamically compared at the time of providing access to resources in the IoT network. Further, the system 102 may switch the user profile dynamically based on the current time of the day. This switching of the user profile is performed by the resource controlling module 220 of the system 102.

In one example, the controlling of resources may be referred as generating a group of commands to set state of devices that are present in IoT network 108 such as a house, a building, a car, an airport and the like. For example, while watching a TV program in a hall, a user may want to close all the curtains, switch off all lights and keep one dimmer light on, AC on etc. Without user profile in place, a user has to control all hall devices individually as per his/her preference. To address this problem, the system 102 enables the user to specify his preferred settings for each device/resources in the IoT network 108 and accordingly configures the resources, once the user is within the vicinity of the IoT network 108.

Further, the system 102 may enable updating the user profile using the device 104, at a later point of time. The user profile may contain the information as represented in table 3.

| Profile | | |
|---|---|---|
| Identifier | Profile Name | Devices Settings |
| PA1 | Kid1PA | HallLight1 - Off |
| | | HallLight2 - On |
| | | HallCurtain1 - Close |
| | | AC - ON |
| | | AC Temp - 25 |
| | | TV volume - 20 |
| | | TV Channel - 522 |
| PA2 | Kid2PA | Hallight1 - Off |
| | | HallLight2 - On |
| | | HallCurtain1 - Close |
| | | AC - ON |
| | | AC Temp - 22 |
| | | TV volume - 25 |
| | | TV Channel - 532 |
| PA3 | Adult1PA | Bedroom Bed Light - On |
| | | HallLight1 - Off |
| | | HallLight2 - Off |
| | | HallCurtain1 - Close |
| | | TV volume - 50 |
| | | TV Channel - 150 |
| | | AC - Off |

In one embodiment, the system 102 may enable use of device 104 for performing operation such as update, modify and delete user profile stored in the profile database 112.

Although implementations of methods and systems for controlling resources in an Internet of Things (IoT) network is disclosed, it is to be understood that the appended claims are not necessarily limited to the specific features or methods described herein. Rather, the specific features and methods are disclosed as examples of implementations for controlling resources in an Internet of Things (IoT) network.

We claim:

1. A method for controlling resources in an Internet of Things (IoT) network, the method comprising:
detecting, by a processor, presence of a user in a vicinity of an Internet of Things (IoT) network, wherein the presence of the user is detected based on an access control signal received from a wearable device of the user, wherein the access control signal indicates a request for controlling one or more resources in the IoT network;
prompting, by the processor, the wearable device to continuously transmit biometric authentication information and a profile identifier associated with the user at successive time intervals;
receiving, by the processor, the biometric authentication information and the profile identifier from the wearable device, wherein the biometric authentication information is generated by the wearable device based on comparison of a biometric sample captured from the user with a golden copy of the biometric sample;
identifying, by the processor, a user profile associated with the user based on the biometric authentication information and the profile identifier, wherein the user profile is identified from a profile database; and
calibrating, by the processor, the one or more resources in the IoT network based on the user profile.

2. The method of claim 1, wherein the access control signal is received using wireless communication.

3. The method of claim 1, wherein the user profile includes the profile identifier, a wearable device identifier, personalized configuration settings for each resource from the one or more resources and a privilege level of the user.

4. The method of claim 3, wherein the privilege level of the user is used for resolving conflicts between the user and other users to access the one or more resources.

5. The method of claim 1, wherein the biometric sample is captured in a real-time, and wherein the biometric sample is one of a fingerprint, a pulse rate, a face image, eye retina image and a combination thereof.

6. The method of claim 1, wherein the one or more resources include a set of home appliances.

7. A system for controlling resources in an Internet of Things (IoT) network, the system comprising:
a processor; and
a memory coupled to the processor, wherein the processor is configured to execute a set of instructions stored in the memory for:
detecting presence of a user in a vicinity of an Internet of Things (IoT) network, wherein the presence of the user is detected based on an access control signal received from a wearable device of the user, wherein the access control signal indicates a request for controlling one or more resources in the IoT network;
prompting the wearable device to continuously transmit biometric authentication information and a profile identifier associated with the user at successive time intervals;
receiving the biometric authentication information and the profile identifier from the wearable device, wherein the biometric authentication information is generated by the wearable device based on comparison of a biometric sample captured from the user with a golden copy of the biometric sample;
identifying a user profile associated with the user based on the biometric authentication information and the profile identifier, wherein the user profile is identified from a profile database; and
calibrating the one or more resources in the IoT network based on the user profile.

8. The system of claim 7, wherein the access control signal is received using wireless communication.

9. The system of claim 7, wherein the user profile includes the profile identifier, a wearable device identifier, personalized configuration settings for each resource from the one or more resources and a privilege level of the user.

10. The system of claim 9, wherein the privilege level of the user is used for resolving conflicts between the user and other users to access the one or more resources.

11. The system of claim 7, wherein the biometric sample is captured in a real-time, and wherein the biometric sample is one of a fingerprint, a pulse rate, a face image, eye retina image and a combination thereof.

12. The system of claim 7, wherein the one or more resources include a set of home appliances.

13. A computer program product having embodied thereon a computer program for controlling resources in an Internet of Things (IoT) network, the computer program product comprising:
a program code for detecting presence of a user in a vicinity of an Internet of Things (IoT) network, wherein the presence of the user is detected based on an access control signal received from a wearable device of the user, wherein the access control signal indicates a request for controlling one or more resources in the IoT network;
a program code for prompting the wearable device to continuously transmit biometric authentication information and a profile identifier associated with the user at successive time intervals;
a program code for receiving the biometric authentication information and the profile identifier from the wearable device, wherein the biometric authentication information is generated by the wearable device based on comparison of a biometric sample captured from the user with a golden copy of the biometric sample;
a program code for identifying a user profile associated with the user based on the biometric authentication information and the profile identifier, wherein the user profile is identified from a profile database; and
a program code for calibrating the one or more resources in the IoT network based on the user profile.
